(19) United States
(12) Patent Application Publication
(10) Pub. No.: US 2003/0082364 A1
(43) Pub. Date: May 1, 2003

(54) Foam sheet and a method to manufacture a foam sheet

(76) Inventors: Michael W. Jary, Farminton Hills, MI (US); Suresh D. Shah, Troy, MI (US)

Correspondence Address: Kathryn A. Marra, Delphi Technologies, Inc., 1450 West Long Lake, Troy, MI, 48098, US

(21) Appl. No.: 10/020,078

(22) Filed: Oct. 29, 2001

(51) Int. Cl. B32B 7/02

(52) U.S. Cl. 428/317.9; 428/212

(57) ABSTRACT

In one embodiment, the method to produce a foamed material with variable cross-linking comprises mixing a first resin, a first blowing agent, and a first cross-linking agent to form a first mixture and mixing a second resin, a second blowing agent, and a second cross-linking agent to form a second mixture and cross-linking the first mixture and the second mixture such than the amount of cross-linking in the first mixture differs from the amount of cross-linking in the second mixture. The first mixture and second mixture may be co-extruded to form an extrudate having a varying amount of cross-linking across the thickness of the extrudate. The blowing agent is activated to result in a foamed material.

In another embodiment, the method to produce a foamed material with variable cross-linking comprises forming a material comprising a resin, a blowing agent and a cross-linking agent; cross-linking the formed material to result in a material with a varying amount of cross-linking; and activating the blowing agent to result in a foamed material.

### TECHNICAL FIELD

The present disclosure is related to a foam sheet and a method for manufacture thereof.

### BACKGROUND

Trim materials employed in applications such as automotive interiors require a several levels of softness. As a result, materials requiring a soft touch generally employ a foamed material. Generally, these foamed materials are bonded to a protective layer by methods such as lamination to form a multi-layer material which is then molded, typically insert molded, into the desired shape. The protective layer of the multi-layer material is used to prevent damage to the foam during insert molding. Unfortunately, the formation of the multi-layer material can be time consuming and costly, especially because formation of the multi-layer material, as well as the later insert molding, can result in damage to the foam and a high scrap rate.

### BRIEF SUMMARY

In one embodiment, the method to produce a foamed material with variable cross-linking comprises mixing a first resin, a first blowing agent, and a first cross-linking agent to form a first mixture and mixing a second resin, a second blowing agent, and a second cross-linking agent to form a second mixture and cross-linking the first mixture and the second mixture such that the amount of cross-linking in the first mixture differs from the amount of cross-linking in the second mixture. The first mixture and second mixture can be co-extruded to form an extrudate having a varying amount of cross-linking across the thickness of the extrudate or the first mixture and the second mixture can be processed into the desired form and then bonded together. The blowing agent can then be activated to result in a foamed material.

In another embodiment, the method to produce a foamed material with variable cross-linking comprises processing a mixture comprising a resin, a blowing agent and a cross-linking agent to form a material; cross-linking the material to result in a variably cross-linked material; and activating the blowing agent to result in a foamed material with variable cross-linking.

The above-described and other features will be appreciated and understood by those skilled in the art from the following detailed description and appended claims.

### DETAILED DESCRIPTION OF THE INVENTION

In one embodiment, the method to produce a foamed material with variable cross-linking comprises mixing a first resin, a first blowing agent, and a first cross-linking agent to form a first mixture and mixing a second resin, a second blowing agent, and a second cross-linking agent to form a second mixture and cross-linking the first mixture and the second mixture such than the amount of cross-linking in the first mixture differs from the amount of cross-linking in the second mixture. The first mixture and second mixture can be co-extruded to form an extrudate having a varying amount of cross-linking, preferably across the thickness of the extrudate. The blowing agent can then be activated to result in a foamed material.

Alternatively the first mixture and second mixture may be produced as described above and then the first mixture and the second mixture may be independently formed into an article such as a sheet. The resulting first and second articles may then be bonded together (e.g., through lamination or other means) followed by activation of the blowing agent(s) to result in a foamed material with variable cross-linking.

In another embodiment, the method to produce a foamed material with variable cross-linking comprises processing a mixture comprising a resin, a blowing agent and a cross-linking agent to form a material; cross-linking the material to result in a variably cross-linked material; and activating the blowing agent after cross-linking to result in a foamed material with a varying amount of cross-linking. Cross-linking can be achieved by the use of irradiation, for example, wherein the amount of radiation on one side of the mixture is greater than the amount of radiation on the other side. The mixture is preferably processed into a sheet that after cross-linking has a varying amount of cross-linking across its thickness.

Regardless of the method employed to obtain the foamed material with varying cross-linking it is preferable for the amount of cross-linking of the two sides to differ by greater than or equal to about 2%, more preferably by greater than or equal to about 3% and most preferably by greater than or equal to about 5%. Generally the difference in the amount of cross-linking of the two sides is less than or equal to about 40% and preferably less than or equal to about 30% and most preferably less than or equal to about 20%.

Foamed material with variable cross-linking has a number of advantages. Having a higher degree of cross-linking on one side allows the foamed material to be used at higher temperature and pressure conditions than universally cross-linked foamed materials for bonding processes such as insert molding, without the need for a protective layer. Advantageously, desired tactile characteristics of the foamed material are maintained. Additionally, the foamed material with variable cross-linking can be used to make products comprising higher melt plastics than could be made with universally crosslinked foamed material.

In embodiments employing two mixtures, the first resin may be the same as or different from the second resin. If the first resin is different from the second resin then the two resins are preferably compatible so as to prevent separation of the resulting layers. Preferably the two resins should be capable of cross-linking with each other and have similar melt viscosity range, and even more preferably the first resin and the second resin comprise at least one common resin material.

Useful resins include thermoplastic resins, elastomers, and combinations comprising at least one of the foregoing. Useful resin mixtures comprise about 20 weight percent (wt %) to about 80 wt % of thermoplastic resin and about 80 wt % to about 20 wt % of elastomer based on the total weight of the composition. Polyolefin resins, either singly or in combination with another resin, are preferred.

Suitable elastomers include, but are not limited, to polyolefins, natural rubbers, synthetic rubbers, and combinations comprising at least one of these elastomers. Suitable synthetic rubbers include, but are not limited to, polybutadiene rubbers; styrene-butadiene rubbers; acrylonitrile butadiene rubbers; polychloroprene; polychlorobutadiene; polyisoprene (generally having a high cis-1 content); butyl rubbers such as isobutene-isoprene rubbers; polyolefins such as polyethylene, ethylene-propylene rubbers, and the like; copolymers of olefins, such as ethylene, propylene, butene, hexane, octene, ethylidene norbornene, and the like; ionomers such as copolymers of olefins, particularly alpha-olefins, carboxylic acid monomers, such as methacrylic acid, and the like; fluorine rubber (generally formed by copolymerization of hexafluoropropylene with vinylidene fluoride); chlorosulfinated polyethylene; silicone rubbers; and any combination comprising at least one of the foregoing synthetic rubbers.

Useful polyolefins comprise the general structure CₙH₂ₙ. Some examples include polyethylene, polypropylene, polyisobutylene, as well as combinations comprising at least one of the foregoing polyolefins, with preferred homopolymers being polyethylene, ULDPE (ultra low linear density polyethylene), LLDPE (linear low density polyethylene), HDPE (high density polyethylene) and MDPE (medium density polyethylene), isotatic polypropylene, as well as combinations comprising at least one of the foregoing polyolefins. Polyolefin resins of this general structure and methods for their preparation are described for example in U.S. Pat. Nos. 2,933,480; 3,093,621; 3,211,709; 3,646,168; 3,790,519; 3,884,993; 3,894,999; 4,059,654; 4,166,055 and 4,584,334. Copolymers of polyolefins may also be used such as copolymers of ethylene and alpha olefins like propylene and 4-methylpentene-1. Copolymers of ethylene and C₃-C₁₀ monoolefins and non-conjugated dienes, herein referred to as EPDM copolymers, are also suitable. Examples of suitable C₃-C₁₀ monoolefins for EPDM copolymers include propylene, 1-butene, 2-butene, 1-pentene, 2-pentene, 1-hexene, 2-hexene, 3-hexene, and the like. Suitable dienes include 1,4 hexadiene, monocyclic and polycyclic dienes, and the like. Mole ratios of ethylene to other C₃-C₁₀ monoolefin monomers can be about 95:5 to about 5:95 with diene units preferably being present in the amount of about 0.1 to about 10 mole percent (mol %). EPDM copolymers can be functionalized with an acyl group or electrophilic group for grafting onto the polyphenylene ether as disclosed in U.S. Pat. No. 5,258,455. Although the polyolefin can comprise any of the above materials as well as combinations comprising at least one of these materials, the preferred polyolefin is polypropylene.

The cross-linking agents are typically chosen based on the resin. In embodiments employing two mixtures, the first cross-linking agent may be the same as or different from the second cross-linking agent.

Representative cross-linking agents include organic peroxides, azido and vinyl functional silanes, multifunctional vinyl monomers, organo-titanates, organo-zirconates, p-quinone dioximes, sulfur, as well as combinations comprising at least one of the foregoing cross-linking agents. Elemental sulfur is particularly useful as a cross-linking agent for diene containing polymers such as EPDM and polybutadiene. Suitable organic peroxide cross-linking agents include, but are not limited to, alkyl and aralkyl peroxides. Examples of such peroxides include: dicumylperoxide, 2,5-dimethyl-2,5-di(t-butylperoxy) hexane, 1,1-bis(t-butylperoxy)-3,3,5-trimethylcyclohexane, 1,1-di-(t-butylperoxy)-cyclohexane, 2,2′-bis (t-butylperoxy) diisopropylbenzene, 4,4′-bis(t-butylperoxy) butylvalerate, t-butyl-perbenzoate, t-butylperterephthalate, t-butyl peroxide, and the like, as well as combinations comprising at least one of the foregoing organic peroxides.

Azido-functional silanes have the general formula RR¹SiY₂, in which R represents an azido-functional radical attached to silicon through a silicon-to-carbon bond and composed of carbon, hydrogen, optionally sulfur and oxygen; each Y represents a hydrolyzable organic radical; and R¹ represents a monovalent hydrocarbon radical or a hydrolysable organic radical. Azido-silane compounds can graft onto an olefinic polymer though a nitrine insertion reaction. Cross-linking develops through hydrolysis of the silanes to silanols followed by condensation of silanols to siloxanes. The condensation of silanols to siloxanes is catalyzed by certain metal soap catalysts such as dibutyl tin dilaurate, butyl tin maleate, and the like. Suitable azido-functional silanes include the trialkoxysilanes such as 2-(trimethoxylsilyl) ethyl phenyl sulfonyl azide, (triethoxy silyl) hexyl sulfonyl azide, and the like.

Vinyl functional silanes include vinyl alkoxy silanes such as vinyl trimethoxy silane, vinyl triethoxy silane, and the like. These silane cross-linking agents may be represented by the general formula R²R³ SiZ₂ in which R² represents a vinyl functional radical attached to silicon through a silicon-carbon bond and composed of carbon, hydrogen, and optionally oxygen or nitrogen, each Z represents a hydrolyzable organic radical, and R represents a hydrocarbon radical or Z.

Usually, free-radical initiating species, such as the organic peroxides described above, are incorporated along with the vinyl alkoxy silane to perform hydrogen extraction from the polymeric backbone, whereupon the vinyl-functional silane may react and graft thereto. Subsequently, the grafted polymeric composition may be exposed to moisture to effect silanolysis condensation reactions therein to cross-link multiples of pendant silane grafts.

Preferably, the cross-linking agent, which can comprise any one of the above-mentioned cross-linking agents, as well as combinations comprising at least one of these cross-linking agents, is present in an amount of less than or equal to about 1 weight percent (wt %) based upon the total weight of the composition (cross-linking agent, resin, and blowing agent). More preferably, the cross-linking agent is present in an amount of about 0.05 wt % to about 0.75 wt %, with about 0.1 wt %to about 0.5 wt % even more preferred. About 0.1 wt % to about 0.5 wt % of dicumyl peroxide is especially preferred.

Free radical cross-linking initiation via electron beam, or beta-ray, gamma-ray, x-ray, or neutron rays may also, or alternatively, be employed. Radiation is believed to affect cross-linking by generating polymer radicals, which may combine and cross-link.

Combined with the cross-linking agent and the resin is at least one blowing agent. Suitable blowing agents include gaseous agents, those which undergo a phase change from liquid to gas during the foaming process, among others. The blowing agent is used primarily for controlling the density of the foam. The agent, typically dissolved in the polymer under high pressure and temperature, comes out of solution and creates bubbles when the pressure and/or temperature decrease. The physical blowing agent acts as a plasticizer, reducing the viscosity and lowering the temperature necessary to maintain the hot melt or plasticated condition of the foaming mixture. While the blowing agent may be added prior to cross-linking, it is preferable for the blowing agent to be added after the cross-linking agent and resin have been combined and the resin lightly cross-linked, typically greater than or equal to about 1%, preferably greater than or equal to about 5%. Preferably the amount of cross-linking is less than or equal to about 40% and more preferably less than or equal to about 20% prior to the addition and/or the activation of the blowing agent. Cross-linking increases the melt tension and melt viscosity of the polymer material, while permitting it to remain flowable. The increase in melt tension and melt viscosity serves to minimize cell rupture during the activation of the blowing agent.

The blowing agent is typically chosen based upon the desired properties of the final foam and the resin. Therefore, it will be readily appreciated that in embodiments employing two mixtures, the first blowing agent may be the same as or different from the second blowing agent. Additionally the blowing agent and the amount of blowing agent in each mixture may be manipulated so as to obtain foamed materials the desired foamed characteristics. For example, the first mixture and the second mixture may employ the same blowing agent in different amounts resulting in different levels of foaming or employ the same amount of the same blowing agent resulting in similar levels of foaming. Alternatively the first and second mixtures may employ different blowing agents, which depending on the amount employed, may result in the same or different levels of foaming.

Useful blowing agents include hydrocarbons such as butane and isopentane, chlorinated hydrocarbons, chlorofluorcarbons, nitrogen, carbon dioxide, other inert gases, and combinations comprising at least one of the foregoing blowing agents. In addition, the blowing agents can include one or more chemical compounds, for example, exothermic chemical blowing agents such as azodicarbonamide, azodiisobutyronitrile, 4,4-oxybenzene sulfonylsemicarbazide, p-toluene sulfonylsemicarbazide, and the like, or endothermic chemical blowing agents such as sodium bicarbonate, both of which induce foaming by decomposing into a gas upon heating. These agents are optionally and preferably in solid form so that they may be easily dry-blended with the resin and can be added in a concentrated form. Mixtures of chemical blowing agents may also be used. The blowing agent is preferably chosen such that the activation temperature of the blowing agent is greater than the temperature at which cross-linking occurs and less than the decomposition temperature of the resin.

The concentration of blowing agent is typically greater than or equal to about 1 weight percent (wt %). Preferably the concentration of the blowing agent is less than or equal to about 10 wt %, with about 1 wt % to about wt % preferred, and about 1 wt % to about 3 wt % especially preferred, based upon the total weight of the composition (resin, cross-linking agent, and blowing agent). The higher the concentration of the blowing agent, the lower the foam density due to the combined effects of higher pressure in the cell and the lower resistance of the cell wall to deformation because of the plasticizing action of the blowing agent. Additionally, an increase in blowing agent concentration in the melt reduces the melt viscosity and the processing temperature. Consequently, the ultimate concentration of the blowing agent is based upon the desired foam density, melt viscosity, and processing temperature.

In addition to the resin, blowing agent and cross-linking agent, additives may be included in effective amounts. Useful additives include antioxidants, flame retardants, drip retardants, dyes, coloring pigments, stabilizers, particle fillers, antistatic agents, plasticizers, lubricants, color concentrate-stabilizer concentrations and mixtures comprising one or more of the foregoing additives. Effective amounts of the additives vary widely, but they are usually present in an amount up to about 10 wt. %, based on the weight of the entire composition.

The foamed material with variable cross-linking may be formed using various mixing devices, such as kneaders, mixers, extruders (e.g., a twin screw extruder (also known as a tandem extruder) or a single screw extruder), and the like, with extruders preferred. Artisans will appreciate that the twin screw extruder may be of the co-rotating type or the counter-rotating type. Each type of twin screw extruder is effective in conducting the mixture of resin and additives through the necessary cross-linking, mixing and cooling steps.

In one embodiment, a first resin, first cross-linking agent, and first blowing agent are added to a primary mixing device, preferably an extruder, to form a first mixture. If desired, the first resin may be pre-mixed with the first cross-linking agent and may also be cross-linked prior to the addition of the blowing agent. The blowing agent is preferably added after the desired cross-linking is complete. A second resin, second cross-linking agent, and second blowing agent are added to a secondary mixing device, preferably an extruder, to form a second mixture in a manner similar to the formation of the first mixture. The first and second mixtures may then be co-extruded. Preferably, the primary and secondary extruders, when used, are connected in a manner so as to allow co-extrusion. The co-extrusion die may be, for example, a manifold type or a feed-block type. Additionally, it may be a sheet die or a ring (tube) die. When a ring (tube) die is employed, the resulting foam tube may be slit to result in a sheet. The co-extruded material is preferably foamed immediately upon exiting the extruder.

Alternatively, the first mixture and the second mixture may be formed into articles, such as sheets, separately. The articles may then be bonded together by various methods such as using a bonding agent, by lamination or the like with lamination preferred. Following bonding, the material is foamed.

In an alternate embodiment the resin, cross-linking agent, and blowing agent are combined in a mixing device, preferably an extruder. The resin and the cross-linking agent may be pre-mixed before being added to the mixing device. After mixing, the material comprising the resin, cross-linking agent and blowing agent is formed, preferably into a sheet, by an extruder. The extrusion die may be, for example, a manifold type or a feed block type. Additionally, it may be a sheet die or a ring (tube) die as discussed above with regard to the other embodiment. Cross-linking occurs after forming the material, preferably by passing the formed material through an irradiation chamber wherein the irradiation level is not equivalent on both sides of the chamber resulting in a material with variable cross-linking. The material is then foamed by activating the blowing agent, which typically entails passing the material through a high temperature oven.

As will be readily appreciated, the above described method produces a foamed material, preferably a sheet, with a variable amount of cross-linking across one dimension, preferably the thickness.

The foam sheet can be used to produce foam backed trim materials such as: foam backed vinyl, cloth, etc. These materials can be used in in-mold lamination processes (such as low pressure molding, insert molding, compression molding, etc.) where the foam backed trim is placed into the mold and molten polymer is introduced behind the trim, which produces a trim covered molded article upon completion of the molding process.

The above described foamed material has a greater amount of cross-linking on one side of the material compared to the other side. The greater cross-linking on one side allows the material to be used in combination with a wider range of materials than is possible with foamed materials with uniform cross-linking. The foamed material with a varied amount of cross-linking can have either two levels of cross-linking across the material or a gradient of cross-linking across the material, thus allowing control of a range of properties such as heat resistance during molding, allowing use of plastics with higher melt temperatures, improved compression set properties in the final product; and improved high temperature performance of the final product. Additionally, it is also possible to cross-link a second time after foaming through irradiation or the like. This allows the foam sheet to be produced with lower density without compromising the heat resistance required during the end-use process (such as low pressure molding, insert molding, compression molding, etc.).

All patents cited are incorporated herein by reference.

While preferred embodiments have been shown and described, various modifications and substitutions may be made thereto without departing from the spirit and scope of the invention. Accordingly, it is to be understood that the method has been described by way of illustration only, and such illustrations and embodiments as have been disclosed herein are not to be construed as limiting to the claims.

1. A method to produce a foamed material with variable cross-linking comprises:
processing a mixture comprising a resin, a blowing agent and a cross-linking agent to form a material;
cross-linking said material to result in a variably cross-linked material; and
activating said blowing agent to result in the foamed material with variable cross-linking.

2. The method of claim 1, wherein said resin comprises a thermoplastic resin, an elastomer, a mixture of a thermoplastic and an elastomer, or a combination comprising at least one of the foregoing resins.

3. The method of claim 2, wherein said resin comprises polypropylene.

4. The method of claim 1, wherein said cross-linking agent comprises an organic peroxide, azido functional silane, a vinyl functional silane, a multifunctional vinyl monomer, an organo-titanate, an organo-zirconate, a p-quinone dioxime, sulfur, or a combination comprising at least one of the foregoing cross-linking agents.

5. The method of claim 1, wherein said blowing agent comprises a hydrocarbon, a chlorinated hydrocarbon, a chlorofluorocarbon, nitrogen, carbon dioxide, or a combination comprising at least one of the foregoing blowing agents.

6. The method of claim 1, wherein said mixture further comprises an anti-oxidant, flame retardant, drip retardant, dye, coloring pigment, stabilizer, particulate filler, antistatic agent, plasticizer, lubricant, color concentrate-stabilizer concentration or a mixture comprising one or more of the foregoing additives.

7. The method of claim 1, wherein said cross-linking occurs by irradiation in an irradiation chamber where the irradiation level is not equivalent on two sides.

8. The method of claim 1, wherein said foamed material has a first side and a second side and the amount of cross-linking of the first side differs from the amount of cross-linking of a second side by about 2% to about 40%.

9. The method of claim 8, wherein the amount of cross-linking of the first side differs from the amount of cross-linking of the second side by about 3% to about 30%.

10. The method of claim 9, wherein the amount of cross-linking of the first side differs from the amount of cross-linking of the second side by about 5% to about 20%.

11. An article of manufacture produced by the method of claim 1.

12. A method to produce a foamed material with variable cross-linking comprises:
mixing a first resin, a first blowing agent, and a first cross-linking agent to form a first mixture;
mixing a second resin, a second blowing agent, and a second cross-linking agent to form a second mixture;
cross-linking the first mixture and the second mixture such that the amount of cross-linking in said first mixture differs from an amount of cross-linking in said second mixture;
processing said first mixture and said second mixture; and
activating said blowing agent to result in a foamed material.

13. The method of claim 12, wherein said processing comprises coextruding said first mixture and said second mixture.

14. The method of claim 12, wherein said processing comprises forming said first mixture in a first article and forming said second mixture into a second article and bonding said first article to said second article.

15. The method of claim 14, wherein said bonding comprises laminating or using a bonding agent.

16. The method of claim 12, wherein said first resin and said second resin independently comprise a thermoplastic resin, an elastomer, a mixture of a thermoplastic and an elastomer or a combination comprising one of the foregoing resins.

17. The method of claim 12, wherein said first resin or second resin comprises polypropylene.

18. The method of claim 12, wherein said first resin and said second resin comprise the same resin.

19. The method of claim 12, wherein said first resin and said second resin comprise different resins.

20. The method of claim 12, wherein said first cross-linking agent and said second cross-linking agent independently comprise an organic peroxide, azido functional silane, a vinyl functional silane, a multifunctional vinyl monomer, an organo-titanate, an organo-zirconate, a p-quinone dioxime, sulfur or a combination comprising at least one of the foregoing cross-linking agents.

21. The method of claim 12, wherein said first cross-linking agent and said second cross-linking agent comprise the same cross-linking agent.

22. The method of claim 12, wherein said first cross-linking agent and said second cross-linking agent comprise different cross-linking agents.

23. The method of claim 12 wherein said first blowing agent and said second blowing agent independently comprise a hydrocarbon, a chlorinated hydrocarbon, a chlorofluorocarbon, nitrogen, carbon dioxide, or a combination comprising at least one of the foregoing blowing agents.

24. The method of claim 12, wherein said first mixture and/or said second mixture further comprise an anti-oxidant, flame retardant, drip retardant, dye, coloring pigment, stabilizer, particulate filler, antistatic agent, plasticizer, lubricant, color concentrate-stabilizer concentration or a combination comprising one or more of the foregoing additives.

25. The method of claim 12, wherein the amount of cross-linking of said first mixture differs from the amount of cross-linking of said second mixture by about 2% to about 40%.

26. The method of claim 12, wherein the amount of cross-linking of said first mixture differs from the amount of cross-linking of said second mixture by about 3% to about 30%.

27. The method of claim 12 wherein the amount of cross-linking of said first mixture differs from the amount of cross-linking of said second mixture by about 5% to about 20%.

28. The method of claim 12 further comprising further cross-linking the foamed material.

29. A foamed, cross-linked material comprising a resin wherein the amount of cross-linking is greater on a first side than the amount of cross-linking on a second side.

30. The material of claim 29 wherein said amount of cross-linking of said first side differs from said amount of cross-linking of said second side by about 2% to about 40%.

31. The material of claim 30 wherein said amount of cross-linking of said first side differs from said amount of cross-linking of said second side by about 3% to about 30%.

32. The material of claim 31 wherein said amount of cross-linking of said first side differs from said amount of cross-linking of said second side by about 5% to about 20%.

33. The material of claim 30 wherein said resin comprises a thermoplastic resin, an elastomer, a mixture of a thermoplastic and an elastomer or a combination comprising one of the foregoing resins.

34. The material of claim 33 wherein said resin comprises polypropylene.
